(19) United States
(12) Patent Application Publication
(10) Pub. No.: US 2022/0053710 A1
(43) Pub. Date: Feb. 24, 2022

(54) REFRIGERATION SYSTEM WITH HOT GAS BY-PASS

(71) Applicant: Controlled Environments Limited, Winnipeg (CA)

(72) Inventors: Brian MAMROCHA, Winnipeg (CA); Mohsen AKBARZADEH, Winnipeg (CA)

(21) Appl. No.: 17/363,169

(22) Filed: Jun. 30, 2021

(30) Foreign Application Priority Data
Aug. 18, 2020 (CA) 3090680

(51) Int. Cl. A01G 9/24; F25B 1/00; F25B 41/20

(52) U.S. Cl. CPC A01G 9/246; F25B 39/00; F25B 41/20; F25B 1/005

(57) ABSTRACT

A refrigeration system is provided that can be used to cool a plant growth chamber. The refrigeration system can include a compressor to compress refrigerant, a condenser to condense refrigerant, a compressed refrigerant line running from the compressor to the condenser, a throttling device, a condensed refrigerant line running from the condenser to the throttling device, an evaporator to evaporate liquid refrigerant, a throttled refrigerant line running from the throttling device to the evaporator, an evaporated refrigerant line running from the evaporator to the compressor, and, a by-pass line connected to the compressed refrigerant line after the condenser and running to the evaporator. A hot gas proportional valve provided inline of the by-pass line and a liquid proportional valve provided inline of the condensed refrigerant line are used to control the flow of refrigerant through the by-pass line.

### CROSS-REFERENCE TO RELATED APPLICATIONS

This application claims priority under 35 U.S.C. § 119 to Canadian Patent Application Serial No. 3,090,680, filed on Aug. 18, 2020, the disclosure of which is hereby incorporated by reference herein in its entirety and made part of the present U.S. utility patent application for all purposes.

### TECHNICAL FIELD

The present invention relates to a refrigeration system with a hot gas by-pass that passes at least a portion of the refrigerant around the condenser and more particularly where the amount of refrigerant that is routed through the hot gas by-pass is controlled by proportional valves.

### BACKGROUND

Plant growth chambers are used to provide a controlled environment for growing plants. Typically, these plant growth chambers consists of an enclosure provided with shelves and light systems. Plants are grown in this enclosure. These plant growth chambers typically use a series of systems to control the environmental conditions in the enclosure.

The environmental conditions that are controlled typically include temperature, light, humidity, CO2 and others parameters. The control of these environmental conditions must be quite precise because these plant growth chambers are typically used to study the effect of varying the environmental conditions, often quite minutely, and then determining the effects on the growth of the plants. Researchers can vary one or more of these environmental conditions in the enclosure and then study the effect, if any, the change in environmental conditions has on the growth of the plants. In contrast to field studies, the precise control of the environmental conditions in the enclosure, and the ability to change them slightly, allows researchers to determine what environmental conditions will result in what responses in the plants.

The plant growth chambers are not just used for plants, but can also be used to study the environmental effects on tissue cultures, entomology, seed storage, etc.

These plant growth chambers rely on precise control of environmental conditions, such as the temperature. Temperature not only has to be kept precise, but the heat given off by the lights in the growth chamber and the sudden changes in temperature as these lights switch on and off makes precise temperature regulation a challenge.

### SUMMARY OF THE INVENTION

In a first aspect, a refrigeration system is provided. The refrigeration system includes a compressor to compress refrigerant passing through the compressor, a condenser to condense refrigerant passing through the condenser to a liquid, a compressed refrigerant line running from the compressor to the condenser, a throttling device to decrease the pressure of refrigerant passing through the throttling device, a condensed refrigerant line running from the condenser to the throttling device, an evaporator to evaporate liquid refrigerant passing through the evaporator to a vapor, a throttled refrigerant line running from the throttling device to the evaporator, an evaporated refrigerant line running from the evaporator to the compressor, a by-pass line connected at a first end to the compressed refrigerant line upstream from the condenser and running to the evaporator, and, a hot gas proportional valve provided inline of the by-pass line, and, a liquid proportional valve provided inline of the condensed refrigerant line.

In another aspect, a plant growth chamber is provided. The plant growth chamber, can have an enclosure, and, a refrigeration system for cooling the enclosure. The refrigeration system can have a by-pass line connected at a first end to a compressed refrigerant line upstream from a condenser and running to an evaporator, a hot gas proportional valve provided inline of the by-pass line, and, a liquid proportional valve provided inline of a condensed refrigerant line.

In another aspect, a controller for controlling the operation of a refrigerating system having a compressor, a condenser, a compressed refrigerant line running from the compressor to the condenser, a throttling device, a condensed refrigerant line running from the condenser to the throttling device, an evaporator, a throttled refrigerant line running from the throttling device to the evaporator, an evaporated refrigerant line running from the evaporator to the compressor, a by-pass line connected at a first end to the compressed refrigerant line upstream from the condenser and running to the evaporator, a hot gas proportional valve provided inline of the by-pass line, a liquid proportional valve provided inline of the condensed refrigerant line, and, a temperature sensor. The controller can have at least one processing unit, an input interface operatively connectable to the temperature sensor, an output interface operatively connectable to the hot gas proportional valve and the liquid proportional valve, and, at least one memory containing program instructions. The at least one processing unit, responsive to the program instructions, operative to in response to the controller obtaining a temperature measurement that varies from a temperature setpoint, adjust the hot gas proportional valve to change the pressure of the gaseous refrigerant passing through the by-pass line to the evaporator and adjust the liquid proportional valve to change the flow of liquid refrigerant passing through the condensed refrigerant line to the throttling device.

### DESCRIPTION OF THE DRAWINGS

A preferred embodiment of the present invention is described below with reference to the accompanying drawings, in which:

FIG. 1 is a perspective view of a growth chamber;

FIG. 2 is a schematic illustration of a refrigeration system and a growth chamber;

FIG. 3 is a schematic illustration of a controller than can be used to control the refrigeration system of FIG. 2; and

FIG. 4 is a flow chart of a method of controlling the refrigeration system of FIG. 2.

### DETAILED DESCRIPTION

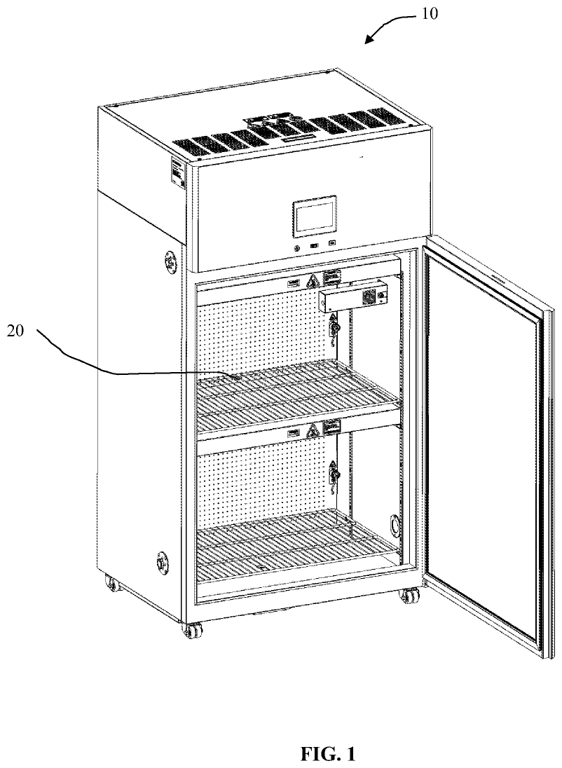

FIG. 1 illustrates a plant growth chamber 10 for growing plants. The plant growth chamber 10 can include an enclosure 20 in which to grow plants. The plant growth chamber 10 can have a number of systems that provide a controlled environment in the enclosure 20. Plants are placed in the enclosure 20, and with the enclosure 20 closed the plant growth chamber 10 controls the environmental conditions in the enclosure 20 and therefore the environmental conditions the plants in the enclosure 20 are subjected to. This can be done to analyze the effects of varying environment conditions on the plants in the enclosure 20 or to grow the plants in the enclosure 20 under optimal conditions.

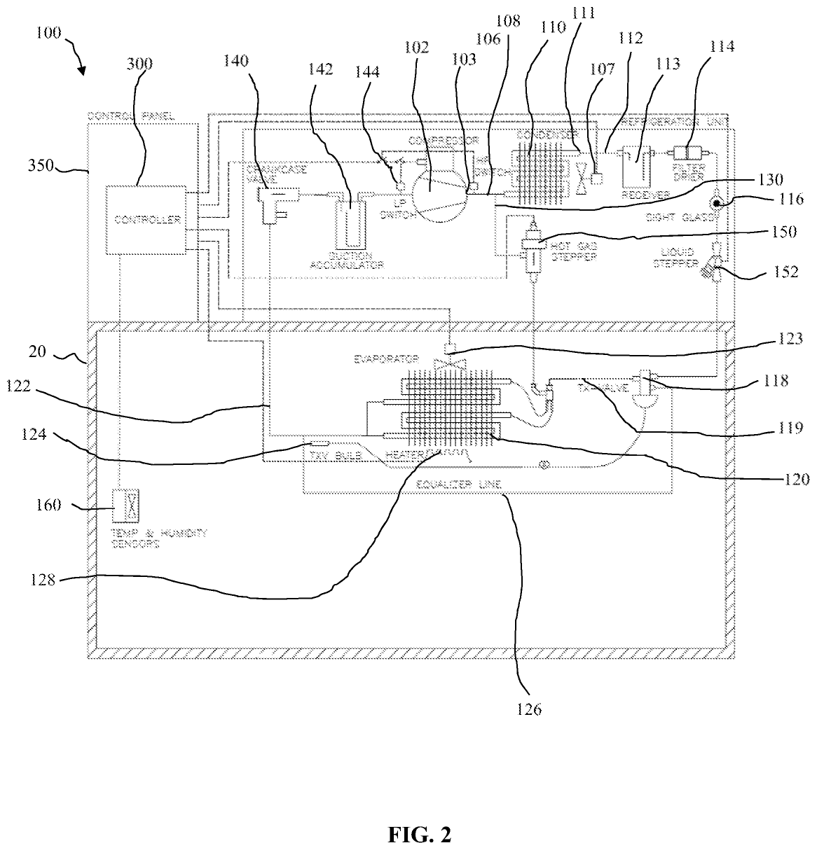

FIG. 2 is a schematic illustration of a refrigeration system 100 for use in a plant growth chamber, like plant growth chamber 10, or any other system that requires precise refrigeration. The refrigeration system 100 is used to cool the enclosure 20 of the plant growth chamber 10.

The refrigeration system 100 can include: a compressor 102; a compressed refrigerant line 108; a condenser 110; a condensed refrigerant line 112; a throttling device 118; a throttled refrigerant line 119; an evaporator 120; an evaporated refrigerant line 122; a by-pass line 130; a hot gas proportional valve 150; a liquid proportional valve 152; a temperature sensor 160; and a controller 300.

The refrigeration system 100 can have a refrigerant that is circulated through the system 100. The compressor 102 can be used to compress the refrigerant, which can enter the compressor 102 as a low temperature and low pressure vapor. The compressor 102 can compress the refrigerant, increasing the pressure and the temperature of the refrigerant, before the refrigerant is discharged from the compressor 102, out a compressor discharge outlet 103 and through the compressed refrigerant line 108 towards the condenser 110.

The compressed refrigerant line 108 can be connected between the compressor discharge outlet 103 and the condenser 110 to route compressed refrigerant from the compressor 102 to the condenser 110. A high pressure safety switch cutoff 106 can be used to ensure the pressure of the refrigerant being discharged from the compressor 102 is not dangerously high.

When the high pressure and high temperature refrigerant reaches the condenser 110, the condenser 110 can condense the refrigerant from a vapor to a liquid. The vaporized refrigerant can travel through the condenser 110, which cools the refrigerant and removes heat from the refrigerant, eventually condensing the refrigerant into a liquid before the liquid refrigerant is discharged from the condenser 110.

A condenser fan 107 can be provided to blow air through the condenser 110 to achieve or help the cooling of the refrigerant in the condenser 110.

The now liquid refrigerant can be routed from the condenser 110 out a condenser discharge outlet 111 and through the condensed refrigerant line 112 to the throttling device 118. A filter drier 114 can be provided in the condensed refrigerant line 112 for filtration and moisture removal from the refrigeration system 100 and a sight glass 116 to check for bubbles in the refrigerant to allow an operator to determine if the refrigerant is properly condensing in the condenser 110.

At the throttling device 118, the pressure of the refrigerant can be quickly decreased to cause flash evaporation of some of the refrigerant causing a mixture of liquid and vapor refrigerant at a lower temperature than the refrigerant entering the throttling device 118. This mixture of liquid and vapor refrigerant discharged from the throttling device 118 can be routed through the throttled refrigerant line 119 to the evaporator 120.

In one aspect, the throttling device 118 can be a thermal expansion valve that controls the amount of refrigerant that passes into the evaporator 120 to ensure that substantially all of the refrigerant that is exiting the evaporator 120 is in the vapor phase. A sensing bulb 124 can be provided to monitor the temperature of the refrigerant leaving the evaporator 120 and control the opening and closing of the thermal expansion valve, to ensure that the amount of refrigerant being passing through the throttling device 118 is of a sufficient amount to be substantially all vapor when it exits the evaporator 120.

A liquid refrigerant receiver tank 113 can be placed inline with the condensed refrigerant line 112. The liquid refrigerant receiver tank 113 can be provided so that in low evaporator thermal load conditions, excess refrigerant that cannot pass through the throttling device 118 can be stored in the liquid refrigerant receiver tank 113, rather than flowing back up the condensed refrigerant line 112 and the condenser 20.

An equalizer line 126 can be provided to connect the throttling device 118 to the evaporator discharge outlet 121 to more efficiently control the throttling device 118 and therefore the superheat of the refrigerant that reaches the evaporator 120.

In the evaporator 120, the liquid and vapor mixture of refrigerant from the throttling device 118 passes through the evaporator 120, which typically consists of a series of tubes or coils, and evaporates so that the refrigerant because substantially vapor. To evaporate the refrigerant, heat from the air surrounding the evaporator 120 is removed, chilling this air, which then cools the enclosure 20 or other space that the refrigeration system 10 is being used to cool. The evaporator 120 can be placed in fluid communication with the enclosure 20 or even provided in the enclosure 20.

An evaporator fan 121 can be provided to blow air through the evaporator 121 to achieve or help the evaporation of the refrigerant in the evaporator 120.

The vaporized refrigerant can exit the evaporator 120 through an evaporator discharge outlet 121 where the vaporized refrigerant is then routed through the evaporated refrigerant line 122 and back to the inlet of the compressor 102.

A heater 128 can be provided adjacent to the evaporator 120. The heater 128 can be used to heat the enclosure 20 if the measured temperature in the enclosure 20 is below the setpoint temperature, the controller 300 is following a schedule that requires the temperature in the enclosure 20 to be raised at a certain time or to raise the temperature after cooling the enclosure 20 as part of a dehumidification strategy.

A crankcase pressure regulating valve 140 can be provided in the evaporated refrigerant line 122 to ensure the suction pressure does not exceed the operating envelope of the compressor 102. A suction accumulator 142 can also be provided inline with the evaporated refrigerant line 112 between the crankcase pressure regulating valve 140 and the compressor 102 to prevent liquid refrigerant from flowing to the compressor 102. A lower pressure safety switch cutout 144 can be provided if the pressure of the refrigerant in the evaporated refrigerant line 122 entering the compressor 102 becomes dangerously low for the compressor 102.

The by-pass line 130 is used to route vaporized, high temperature refrigerant around the condenser 110 when the space being cooled by the refrigeration system 100 is already cool enough and no additional cooling is desired. A first end of the by-pass line 130 can be connected into the compressed refrigerant line 108 upstream from the condenser 110 and a second end of the by-pass line 130 can be connected into the throttled refrigerant line 119. In this manner, the by-pass line 130 can route hot, gaseous refrigerant compressed by the compressor 102 around the condenser 110 and the throttling device 118, and direct in right to the evaporator 120 so that the by-passed hot gas refrigerant does provide heating when it passes through the evaporator 120.

Instead of starting the compressor 102 to have the system provide cooling when cooling is required in the space being cooled and stopping the compressor 102 when cooling is not desired, like in a typical refrigerator, vaporized, high temperature refrigerant is routed through the by-pass line 130 which routes the refrigerant around the condenser 110 and the throttling device 118. Because the refrigerant is not condensed by the condenser 110 into a liquid and then passed through the throttling device 118 to be evaporated in the evaporator 120, the refrigerant that enters the evaporator 120 from the by-pass line 130 is already a vapor at a high pressure and high temperature from the compressor 102. This high temperature vaporized refrigerant will pass through the evaporator 120 without evaporating and drawing heat from the air surrounding the evaporator 120 thereby not causing a cooling effect for this refrigerant that has not passed through the condenser 110. By using the by-pass line 130 to reduce the cooling of the evaporator 120, the compressor 102 can continue to be run, compressing refrigerant and the temperature can be controlled in a more precise manner than by turning off and on the compressor 102 and having to wait for the compressed refrigerant to pass through the refrigeration system 100 and the refrigeration system 100 to begin cooling.

The by-pass line 130 is connected into the compressed refrigerant line 108 upstream from the condenser 110 and routes refrigerant past the condenser 110 and throttling device 118 to the inlet of the evaporator 120. The by-pass line 130 can be connected into the compressed refrigerant line 108 by an unimpeded tee line because the hot gas proportional valve 150 and the liquid proportional valve 152 will control the amount of the compressed refrigerant that flows from the compressed refrigerant line 108 into the by-pass line 130 instead of continuing on to the condenser 110 through the compressed refrigerant line 108.

The hot gas proportional valve 150 can be positioned in-line of the by-pass line 130 to control the flow of the vaporized refrigerant that is passing through the by-pass line 130. The hot gas proportional valve 150 allows the size of the opening in the valve to be adjusted to be able to control the flow of the refrigerant passing through the hot gas proportional valve 150, allowing the hot gas proportional valve 150 to be: fully opened, allowing the refrigerant to flow through the by-bass line 130 unimpeded; closed, stopping the refrigerant from flowing through the by-pass line 130 entirely; or a plurality of amounts of open between fully opened and closed to vary the amount of flow of the gaseous refrigerant passing through the hot gas proportional valve 150.

In one aspect, the hot gas proportional valve 150 can be a gas stepper valve.

The use of the hot gas proportional valve 150 can adjust the amount of gaseous refrigerant that is being routed to the evaporator 120 through the by-pass line 130.

The liquid proportional valve 152 can be positioned inline of the condensed refrigerant line 112 to control the flow of refrigerant, condensed into a liquid by the condenser 110, that is passing through the condensed refrigerant line 112. The liquid proportional valve 152 allows the size of the opening in the valve to be adjusted to be able to control the flow of the liquid refrigerant passing through the liquid proportional valve 152, allowing the liquid proportional valve 152 to be: fully opened, allowing the liquid refrigerant to flow through the condensed refrigerant line 112 unimpeded; closed, stopping the liquid refrigerant from flowing through the condensed refrigerant line 112 entirely; or various amounts of open between fully open and closed of flow through the liquid proportional valve 152 in between.

In one aspect, the liquid proportional valve 152 can be a liquid stepper valve.

The use of the liquid proportional valve 152 can adjust the amount of liquid refrigerant that is being routed to the evaporator 120 to quite quickly change the amount of cooling being provided by the evaporator 120. The adjustment of the hot gas proportional valve 150 and the liquid proportional valve 152, simultaneously and inversely, can very quickly stop liquid refrigerant from reaching the evaporator 120 and quickly reduce or even stop the cooling effect produced by the evaporator 120.

The hot gas proportional valve 150 and the liquid proportional valve 152 can be adjusted substantially simultaneously and inversely, but relative to the other, to control when refrigerant is flowing through the by-pass line 130 and the amount of refrigerant that is routed through the by-pass line 130 and around the condenser 110.

The temperature sensor 160 can be provided in the enclosure 20 to measure the temperature inside the enclosure 20.

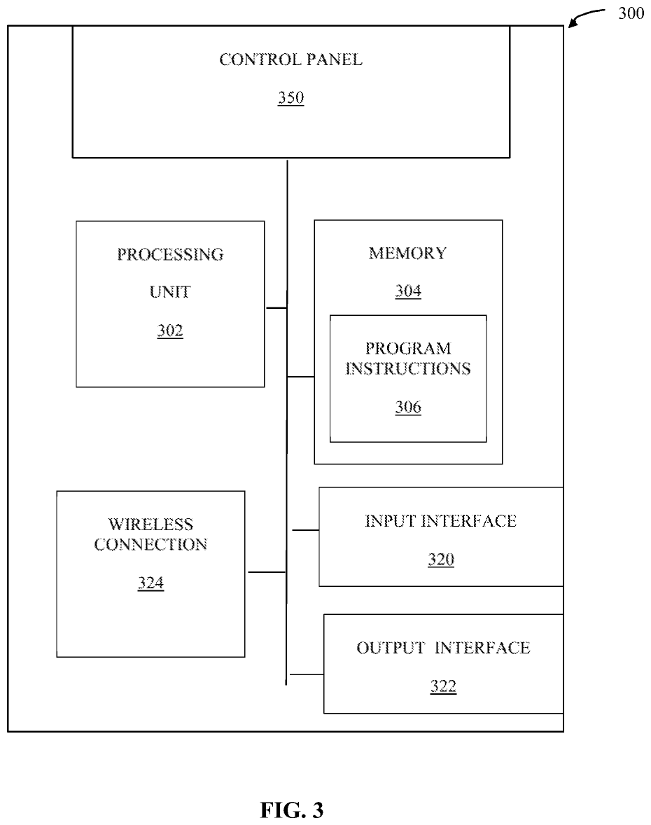

FIG. 3 is a schematic illustration of a controller 300, in one aspect, that can be provided to control the operation of refrigeration system 100 and specifically the operation of the hot gas proportional valve 150 and the liquid proportional valve 152 to control when refrigerant is routed through the by-pass line 130 and the amount of refrigerant that is routed through the by-pass line 130.

The controller 300 can include a processing unit 302, such as a microprocessor that is operatively connected to a computer readable memory 304 and can control the operation of controller 300. Program instructions 306, for controlling the operation of the processing unit 302, can be stored in the memory 304 as well as any additional data needed for the operation of the controller 300.

A control panel 350 can be used to set and adjust the operation of the controller 300. In one aspect, a temperature setpoint indicating the desired temperature of the enclosure 20 can be set using the control panel 350.

An input interface 320 can be provided operatively connected to the processing unit 302 so that the controller 300 can receive signals from external sensors. Referring again to FIG. 2, the controller 300 can be connected through the input interface 320 to the temperature sensor 160 to receive temperature measurements of the temperature in the enclosure 20 the refrigeration system 100 is cooling. The input interface 320 can also be connected to the high pressure switch cutoff 106 and the low pressure cutoff switch 144.

Referring again to FIG. 3, an output interface 322 can be provided operatively connected to the processing unit 302 to send signals to other devices in the refrigeration system 100. Referring again to FIG. 2, the output interface 322 can be connected to the hot gas proportional valve 150 to control the operation of the hot gas proportion valve 150 and whether the valve is closed, open and how open it is. The output interface 322 can also be connected the liquid proportional valve 152 to control the operation of the liquid proportion valve 152 and whether the valve is closed, open and how open it is.

The controller 300 can also be connected through the output interface 322 to the compressor 102 to turn off and on the compressor 102, the condenser fan 107 to turn the condenser fan 107 on and off, the evaporator fan 123 to turn the evaporator fan 123 on and off, and the heater 128.

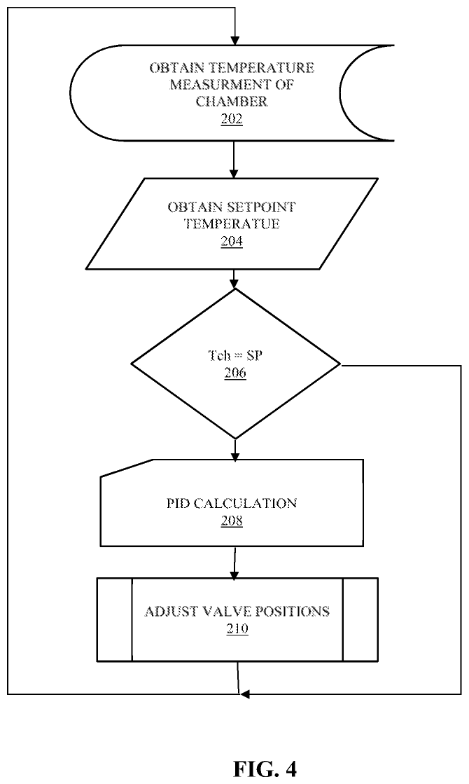

FIG. 4 is a flowchart of a method that can be used by the controller 300 to control the temperature in the enclosure 20 using the refrigeration system 100. The method can be a control loop that continuously cycles through the different steps to try and keep the temperature in the enclosure 20 at a desired setpoint temperature.

The method can start at step 202 with the controller 300 obtaining a temperature measurement from the temperature sensor 160 located in the enclosure 20.

With this obtained temperature measurement, the method can move onto step 204 and obtain the setpoint temperature that will be compared to the measured temperature of the enclosure 20. The setpoint temperature can be obtained from the memory 304 of the controller 300 and set by a user using the control panel 350. The setpoint temperature could be a single setpoint temperature or it could be from table of setpoint temperatures that vary based on time of day so that the enclosure 20 can be set to different temperatures at different times. The setpoint temperature could also be from an outside source, such as a remote file, database, third-party feed, wireless connection, etc.

With the temperature measurement of the enclosure 20 obtained at step 202 and the setpoint temperature obtained at step 204, the controller 300 can move onto step 206 and compare the temperature measurement obtained from the temperature sensor 106 to the setpoint temperature. If the temperature measurement equals the setpoint temperature, than the enclosure 20 is at the desired temperature and no adjustments are necessary to the hot gas proportional valve 150 and the liquid proportional valve 152 and the controller 300 can move back to step 202 and obtain an updated temperature reading from the temperature sensor 160 again before repeating steps 204 and 206. In this manner, as long as the temperature in the enclosure 20 remains at the desired setpoint temperature, the controller 300 will simply continue to monitor the temperature in the enclosure 20 until the temperatures changes.

If at step 206, the temperature measurement does not equal the setpoint temperature, this means the temperature in the enclosure 20 is not at the desired temperature and the hot gas proportional valve 150 and the liquid proportional valve 152 have to be adjusted to bring the temperature in the enclosure 20 back to the desired temperature. The controller 300 can move to steps 208 and 210 where the controller 300 can determine how much to adjust the hot gas proportional valve 150 and the liquid proportional valve 152 at step 208 and then adjusts the hot gas proportional valve 150 and the liquid proportional valve 152 at step 210.

At step 208, the controller 300 can use a PID calculation to determine how much to adjust the hot gas proportional valve 150 and the liquid proportional valve 152 such as by the PID equation as follows:

$$u ( t ) = {K}_{p} ( e ( t ) + \frac{1}{{T}_{i}} {\int }_{0}^{t} e ( t ) d t + {T}_{d} \frac{d e ( t )}{d t} )$$

### Where:

u(t) is the controller output;
Kp is the controller gain which sets the proportional gain or contribution to the direct extent of the error;
e(t) is the differential coefficient, which expresses the difference between the measured temperature inside the enclosure 20 and the setpoint temperature;
Ti is the integral coefficient and is used to integrate the error in time and contributes its action until the error in Kp is cancelled out in its totality;
t is the period of time measurement; and
Td is the derivative time and is used to forecast the error Kp over the change of time Ti.

The controller output determined at step 208 is then used to at step 210 to adjust the apertures in the hot gas proportional valve 150 and the liquid proportional valve 152. If the temperature measurement is different than the setpoint temperature at step 206, the controller 300 controller can substantially simultaneously adjust at step 210 the amount the hot gas proportional valve 150 and the liquid proportional valve 152 are open. While the hot gas proportional valve 150 and the liquid proportional valve 152 may not be adjusted at exactly the same time, they can be adjusted in the same step in series, etc. and in response to the temperature measurement taken at step 202 and compared to the setpoint temperature at step 206. The hot gas proportional valve 150 and the liquid proportional valve 152 can be adjusted relative to one another so that they are adjusted together to get the desired amount of gas flow through the by-pass line 130 and liquid flow through the 112 condensed refrigerant line 112 to adjust the cooling being provided by the evaporator 120.

In an aspect, the adjustment of the hot gas proportional valve 150 can be inverse to the liquid proportional valve 152, with there being a proportional closing of the liquid proportional valve 152 with an opening of the hot gas proportional valve 150 and conversely a proportional opening of the liquid proportional valve 152 with a closing of hot gas proportional valve 150.

In an aspect, the controller output u(t) can be an number between 0 and 1 that indicates how much the hot gas proportional valve 150 should be open, with 0 being closing and 1 being fully opened. A number between 0 and 1 will indicate an amount of opening of the hot gas proportional valve 150 between closed and fully open, with number nearly 0 being more closed and number closer to 1 being closer to fully opened. The inverse of this controller output u(t) can then be used to adjust the opening of the liquid proportional valve 152 opposite to the adjustment of the hot gas proportional valve 150.

If the temperature measurement is greater than the setpoint temperature at step 206, indicating that the temperature in the enclosure 20 is greater than the desired temperature, the controller 300 can move aperture in the hot gas proportional valve 150 more towards being closed while simultaneously moving the aperture in the liquid proportional valve 152 more towards fully open. Moving the aperture in the hot gas proportional valve 150 more towards being closed will increase the pressure of the gas that is passing through the hot gas proportional valve 150 and therefore increase the pressure of the gas passing through the by-pass line 130 to the evaporator 120. The moving of the aperture in the liquid proportional valve 152 more towards its fully open position will increase the flow of liquid through the liquid proportional valve 152 and therefore increase the flow of liquid through the condensed refrigeration line 112 to the throttling device 118 and the evaporator 120. The effect of the moving the aperture in the hot gas proportional valve 150 more towards its closed position, while moving the aperture in the liquid proportional valve 152 more towards it fully open position, will result in less gas passing through the by-pass line 130, with its higher pressure, and more gas being routed through the condenser 110 to condense into liquid and be routed through the condensed refrigeration line 112, to the evaporation 120 to increase the cooling provided by the refrigeration system 100 to the enclosure 20.

Conversely, if the temperature measurement is less than the setpoint temperature, indicating that the temperature in the enclosure 20 is lower than the desired temperature, less cooling has to be provided by the refrigeration system 100 and the controller 300 can move the aperture in the hot gas proportional valve 150 more towards being fully open while simultaneously moving the aperture in the liquid proportional valve 152 more towards its closed position. Moving the aperture in the hot gas proportional valve 150 more towards being fully open will decrease the pressure of the gas that is passing through the hot gas proportional valve 150 and therefore the amount of gas passing through the by-pass line 130 to the evaporator 120. The simultaneous moving of the aperture in the liquid proportional valve 152 more towards its closed position will decrease the flow of liquid through the liquid proportional valve 152 and therefore decrease the flow of liquid through the condensed refrigeration line 112 to the throttling device 118 and the evaporator 120. The effect of the moving the aperture in the hot gas proportional valve 150 more towards its fully open position, while moving the aperture in the liquid proportional valve 152 more towards it closed position, will result in more hot gaseous refrigerant passing through the by-pass line 130 to the evaporator 20, which will reduce the cooling effect of the evaporator 120, and less condensed refrigerant being routed to the evaporation 120. This reduction in the amount of condensed liquid refrigerant being routed to the evaporator 120 while routing more hot gas to the evaporator 120, will decrease the cooling provided by the refrigeration system 100 to the enclosure 20 because the hot gas routed to the evaporator 120 will not be evaporated since it is already vapor and there will be less liquid refrigerant to evaporate in the evaporator 120.

The controller 300 can keep repeating steps 202, 204, 206, 208 and 210 continuing to adjust the hot gas proportional valve 150 and the liquid proportional valve 152 until the temperature in the enclosure 20 measured by the temperature sensor 160 in the enclosure 20 matches the setpoint temperature. Each time the controller 300 performs the PID calculations at step 208, a different adjustment of the hot gas proportional valve 150 and the liquid proportional valve 152 can be determined at implemented at step 210, which can allow the enclosure 20 to achieve the desired setpoint temperature without the refrigeration system 100 overshooting the desired setpoint temperature. For example, the adjustments of the hot gas proportional valve 150 and the liquid proportional valve 152 can be made smaller as the measured temperature in the enclosure 20 gets closer to the setpoint temperature.

Once the measure temperature and the setpoint temperature are equal again at step 206, the controller 300 can continue to move through steps 202, 204 and 206, monitoring the temperature in the enclosure 20 until the measure temperature of the enclosure 20 deviates from the setpoint temperature again.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed:

1. A refrigeration system comprising:
a compressor to compress refrigerant passing through the compressor;
a condenser to condense refrigerant passing through the condenser to a liquid;
a compressed refrigerant line running from the compressor to the condenser;
a throttling device to decrease the pressure of refrigerant passing through the throttling device;
a condensed refrigerant line running from the condenser to the throttling device;
an evaporator to evaporate liquid refrigerant passing through the evaporator to a vapor;
a throttled refrigerant line running from the throttling device to the evaporator;
an evaporated refrigerant line running from the evaporator to the compressor;
a by-pass line connected at a first end to the compressed refrigerant line upstream from the condenser and running to the evaporator;
a hot gas proportional valve provided inline of the by-pass line; and
a liquid proportional valve provided inline of the condensed refrigerant line.

2. The system of claim 1 wherein the hot gas proportional valve is operative to be: completely opened, allowing refrigerant to flow through the by-bass line substantially unimpeded; completely closed, stopping refrigerant from flowing through the by-pass line; and a plurality of amounts of open between fully open and closed.

3. The system of claim 2 wherein the hot gas proportional valve is a stepper valve.

4. The system of claim 1 wherein the liquid proportional valve is operative to be: completely opened, allowing liquid refrigerant to flow through the condensed refrigerant line substantially unimpeded; completely closed, stopping liquid refrigerant from flowing through the condensed refrigerant line; and a plurality of amounts of open between fully open and closed.

5. The system of claim 4 wherein the liquid proportional valve is a stepper valve.

6. The system of claim 1 wherein the hot gas proportional valve and the liquid proportional valve are adjusted substantially simultaneously and inversely.

7. The system of claim 1 further comprising a controller and a temperature sensor, wherein the controller is operative to obtain temperature measurements from the temperature sensor and in response to the controller obtaining a temperature measurement that varies from a temperature setpoint, adjust the hot gas proportional valve to change the pressure of the gaseous refrigerant passing through the by-pass line to the evaporator and adjust the liquid proportional valve to change the flow of liquid refrigerant passing through the condensed refrigerant line to the throttling device.

8. The system of claim 7 wherein the controller is further operative to, in response to obtaining a temperature measurement from the temperature sensor that is greater than the setpoint temperature, adjust the hot gas proportional valve towards closed while substantially simultaneously adjusting the liquid proportional valve more towards open.

9. They system of claim 8 wherein the controller is further operative to, in response to obtaining a temperature measurement from the temperature sensor that is less than the setpoint temperature, adjusting hot gas proportional valve towards fully open while substantially simultaneously adjusting the liquid proportional valve more towards closed.

10. The system of claim 1 further comprising a condenser fan.

11. The system of claim 1 wherein the throttling device is operative to decrease the pressure of the condensed refrigerant passing through the throttling device.

12. The system of claim 1 wherein the throttling device is a thermal expansion valve.

13. The system of claim 1 wherein a second end of the by-pass line is connected to the throttled refrigerant line upstream from the evaporator.

14. A plant growth chamber comprising: an enclosure; and, a refrigeration system in accordance with claim 1 for cooling the enclosure.

15. A controller for controlling the operation of a refrigerating system comprising: a compressor; a condenser; a compressed refrigerant line running from the compressor to the condenser; a throttling device; a condensed refrigerant line running from the condenser to the throttling device; an evaporator; a throttled refrigerant line running from the throttling device to the evaporator; an evaporated refrigerant line running from the evaporator to the compressor; a by-pass line connected at a first end to the compressed refrigerant line upstream from the condenser and running to the evaporator; a hot gas proportional valve provided inline of the by-pass line; a liquid proportional valve provided inline of the condensed refrigerant line; and a temperature sensor, the controller comprising:
at least one processing unit;
an input interface operatively connectable to the temperature sensor;
an output interface operatively connectable to the hot gas proportional valve and the liquid proportional valve; and
at least one memory containing program instructions, the at least one processing unit, responsive to the program instructions, operative to:
in response to the controller obtaining a temperature measurement that varies from a temperature setpoint, adjust the hot gas proportional valve to change the pressure of the gaseous refrigerant passing through the by-pass line to the evaporator and adjust the liquid proportional valve to change the flow of liquid refrigerant passing through the condensed refrigerant line to the throttling device.

16. The controller of claim 15 wherein the hot gas proportional valve is operative to be: completely opened, allowing refrigerant to flow through the by-bass line substantially unimpeded; completely closed, stopping refrigerant from flowing through the by-pass line; and a plurality of amounts of open between fully open and closed.

17. The controller of claim 15 wherein the liquid proportional valve is operative to be: completely opened, allowing liquid refrigerant to flow through the condensed refrigerant line substantially unimpeded; completely closed, stopping liquid refrigerant from flowing through the condensed refrigerant line; and a plurality of amounts of open between fully open and closed.

18. The controller of claim 15 wherein the at least one processing is further operative to, in response to the program instructions, adjust the hot gas proportional valve and the liquid proportional valve substantially simultaneously and inversely.

19. The controller of claim 15 wherein the at least one processing is, in response to the program instructions, further operative to, in response to obtaining a temperature measurement from the temperature sensor that is greater than the setpoint temperature, adjust the hot gas proportional valve towards closed while substantially simultaneously adjusting the liquid proportional valve more towards open.

20. The controller of claim 15 wherein the at least one processing is, in response to the program instructions, further operative to, in response to obtaining a temperature measurement from the temperature sensor that is less than the setpoint temperature, adjusting hot gas proportional valve towards fully open while substantially simultaneously adjusting the liquid proportional valve more towards closed.
